(19) United States
(12) Patent Application Publication
(10) Pub. No.: US 2007/0203780 A1
(43) Pub. Date: Aug. 30, 2007

(54) Organiseand control appointments

(76) Inventors: Maydan Wienreb, Nes Ziona (IL); Daniel Nemenyi-nir, Tel Aviv (IL); Uzi Ezra Havosha, Tel Aviv (IL); Dov Rothfeld, Raanana (IL)

Correspondence Address: UZI EZRA HAVESHA & PARTNERS, HADAR-DAFNA HOUSE 39 SHAOUL HAMELECH STREET, TEL AVIV, 64928, omitted

(21) Appl. No.: 11/712,348

(22) Filed: Mar. 1, 2007

(30) Foreign Application Priority Data
Feb. 27, 2006 (IL) 173949

(51) Int. Cl. G06F 9/46

(52) U.S. Cl. 705/9

(57) ABSTRACT

Computer program attached to communications system, like a central telephone exchange, of an office that organizes and controls appointments with individuals.

Communication to and from individuals by electronic and other means concerning an appointment. Individualized and general advertising addressed to the said individuals waiting for an appointment.

### FIELD OF THE INVENTION

This invention is in the field of communication and more specifically communication between those who have an appointment system for their customers and the customers.

### BACKGROUND OF THE INVENTION

In this document “customer” includes a patient or any person or persons requiring an appointment with a service provider. “Service provider” includes a person, people, companies, government bodies or organizations or other bodies or organizations who provide a service to customers. “Communicate” and its derivatives mean any appropriate means of communication including verbal or written communication in person, by telephone, mobile phone, SMS message, electronic mail, internet or otherwise.

It is well known in many places that the appointment system causes much frustration and/or waste of time. Such appointment systems can be of the kind where a large number of customers are asked to come at the same hour and first come, first served. This causes wastage of time by having to arrive well before the appointed time, in order to receive an early meeting with the service provider. Also, where arrival is later, there will often be a long wait for all those who arrived earlier to be seen first. There is also the unsavory element that sometimes happens in this type of case and that is the arguments that can occur amongst those waiting, debating who came first or, whether or not a turn is lost when a person leaves and later returns.

There can also be the kind of appointment system where each customer is given a consecutive number according to the priority of his arrival. In this case the customers know their order but do not know when their turn will occur. They have to spend much time waiting on the premises or leave to doing something more productive and risk missing their turn.

In these cases, and other similar ones, it would be beneficial for there to be a system where people could order their appointments on or before the day of the appointment. This could be done by any suitable means of communication. Alternatively, the customer could be personally given an appointment at the office in question.

Closer to the time of the appointment a computer program could calculate, for example, the average time spend by each customer with that particular service provider and communicate to the customer for example, half an hour and again ten minutes beforehand, that the time for the appointment is approaching. The service provider or his secretary could indicate to the said computer program as the customer starts his appointment and when he leaves. This would enable the said computer program to calculate more accurately the estimated time of future appointments. This invention alleviates some of the above mentioned problems and aims to reduce time wasted, frustration and unsavory encounters between customers. The invention would also assist the companies or organizations offering the service of this invention by having more satisfied customers and less disgruntlement between themselves and their customers. Before making an appointment, a person could find out what his position would be and how long, approximately, he would have to wait in line, if he were to register his name for an appointment. A customer could communicate with the company or organization to check his position in the line of people waiting for the same service. Companies or organizations using this invention could sell advertising. For example, a customer who has to wait say, half an hour for his appointment could receive a communication that there is a coffee house around the corner. In the case of an hour's wait, a fashion shop may also choose to advertise. The personal details of the customer could be taken into account for example, their age and gender, in order to make more specific and effective advertising.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying flowcharts are included to provide a further understanding of the invention, and are incorporated into and constitute a part of this specification. The flowcharts illustrate various embodiments of the invention and, together with the description serve to explain the principles and operations of the invention.

An object of this invention is to ease the uncertainty of a customer when waiting for an appointment.

Another object of this invention is to maintain a steady and controlled flow of customers for the benefit of the service provider.

Another object of this invention is to enable a customer to order an appointment with a service provider by any suitable means of communication.

Another object of this invention is to communicate to a customer a reminder of an appointment at least once before the said appointment.

Another object of this invention is to enable the customer to choose the said reminder times and failing such choice a default reminder could be communicated to the customer.

Another object of this invention is to cause the said computer program to calculate the average time spent by customers with each particular service provider and communicate to the upcoming customers updated estimated times for their upcoming appointments.

Another object of this invention is to enable a customer to communicate with the said computer program to establish the updated estimated time of his appointment.

Another object of this invention is to enable advertisers to advertise their wares to customers taking into account various factors including the time lapse before that customer's appointment, the distance between the venue of the appointment and the advertiser's premises, where relevant, and taking into account pertinent information about the customer like for example, age and gender.

### BRIEF DESCRIPTION OF THE DRAWINGS

The accompanying flowcharts, which are incorporated in and form a part of this specification, illustrate embodiments of the invention and, together with the description, serve to explain, by way of example only, the principles of the invention:

FIG. 1 is a flow chart showing a scenario of events in the use of this invention.

FIG. 2 is a flow chart showing the basic stages of the workings of the computer program used with this invention.

### DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the flowcharts and description of the embodiments set forth below are to be regarded as illustrative in nature and not restrictive.

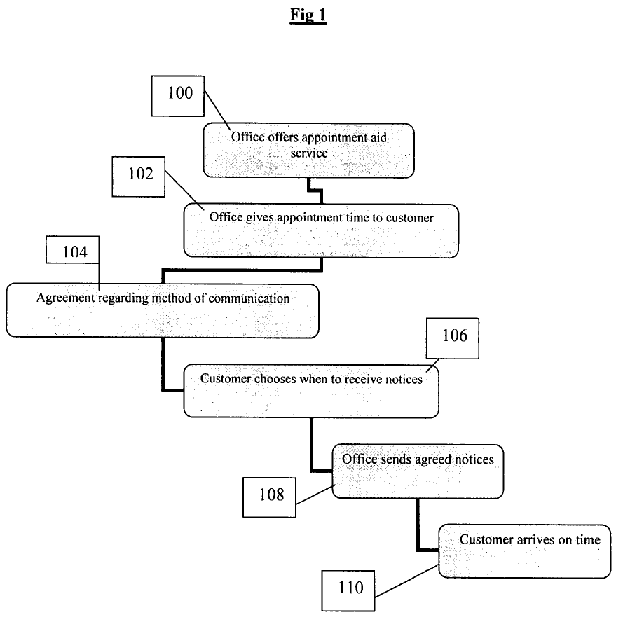

FIG. 1 shows a flow of events using the present invention. The service provider 100 referred to could be any person, company or organization using the appointment system for example, government offices, government services, private doctors in hospitals, health clinics, banks and so on. The office could advertise that they use this invention to attract customers who do not like the present system that causes waste of time and energy. When the customer arrives at the offices of the service provider, it is explained to him how the new appointment system works. The customer is given an appointment 102 and he indicates what type of communication he prefers 104, for example vocal or written message on his mobile phone or e-mail to his PDA.

At this stage, the customer can indicate at what intervals he wishes to be given notice that his appointment time is approaching 106. He may also have the option to change this instruction during the waiting period by communicating with the computer program and giving such instruction verbally or digitally. Failing such customer choice, there could be a default reminder time or times built into the said computer program.

The customer is now able to utilize his time to his best advantage without taking the risk of missing his appointment.

The computer having had the input information of the various customers waiting for appointments, calculates the estimated rate of turnover of prior customers' appointments with each service provider in the organization or company. The customer would be sent the notices, at the times he requested, for example thirty minutes and ten minutes beforehand, that his appointment is approaching 108. He could receive notices before the day of the appointment too. The customer is able to conclude whatever activity he is doing and return to the relevant office in time for his appointment. It will be understood that when a notice is requested thirty and ten minutes beforehand it does not necessarily mean that those two notices will be twenty minutes apart. The “ten minute” notice in the above example could be sooner or later than twenty minutes after the first notice. This would depend on the ongoing calculations of the computer which is given the information when each prior customer or patient starts his meeting and when he finishes.

A different aspect of this invention could include a request by the company or organization for more information from the customer regarding the nature of the appointment. The computer would process this information in order to facilitate more accurate estimates of time for all the approaching appointments.

The present invention would also benefit the service providers who are the appointors of the said appointments. They would be able for instance, to have a break for refreshment or other reason and indicate the same to the computer, which in turn would inform the customer, if it were necessary, to make a change in the upcoming appointment times. This aspect of the invention would probably not be abused by employees, as the employer would be able to obtain from the computer, the detail of how many such breaks were taken by any particular employee. Breaks in excess of an agreed amount could have financial ramifications. The program of the computer could take into account such events as fixed time coffee breaks or irregular events such as staff meetings and the like. The latter kind of meeting would have to be input to the program as soon as they were known. The former regular breaks could be programmed in advance.

With all the above factors taken into account, the customer will have used his time efficiently, will have waited a minimum length of time before the start of the interview and will be more likely to leave that company or organization with satisfaction 110. Likewise the service providers will benefit from the smooth flow of satisfied customers.

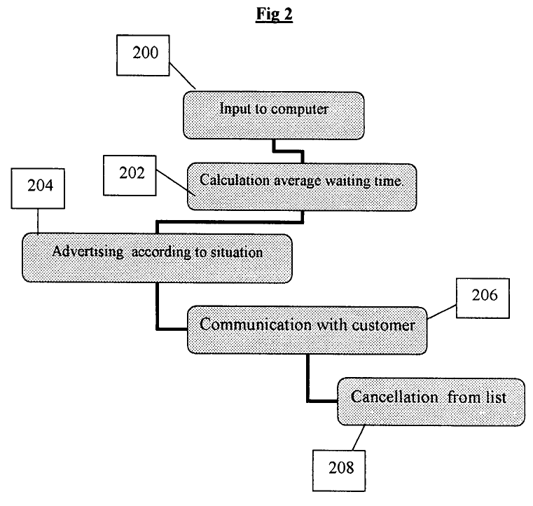

FIG. 2 shows the flow of operations carried out by the computer when programmed to manage this invention. The relevant information has to be input to the program 200 in order for it to make the necessary calculations. The program 5 has to be told which service providers are anticipated to be at work on the following days. This is to enable the aspect of this invention were appointments can be made in advance. Each day, the program will be given the information confirming which service providers are present and available to see customers. This could be done manually or automatically where workers clocking-in machines are connected to the computers of this invention. The program could have standard information about each service provider and the kind of work he does, pre-programmed as this will not usually change from day to day. Where a service provider is ill or for whatever reason does not arrive at work on a day that he expected to be at work and appointments have been made for that day, then the computer or a person could communicate this fact at the earliest opportunity to the customer, so that the latter could adjust his schedule accordingly.

The program needs the information, if such information is relevant, when are fixed breaks. The program needs the information of each customer and allots to him an appointment number to establish his priority. Where appropriate, the program needs to be given the information what kind of appointment is expected so it can more accurately calculate the length of each appointment. This could be a graded system of kinds of appointment, for example, A, B or C being say, one hour, half hour or ten minute appointments. Such details would be individual to each service provider. The time each customer starts his appointment and the time he exits is also input, so a track is kept which customers are still waiting. In addition, the computer will keep updating the time taken for each type of appointment, which in turn will help to calculate the average time customers spend with that service provider and for that particular type of appointment.

All the above information is input to the computer which then calculates the estimated waiting time 202 of the customers who are still waiting for their appointment. The estimated waiting time is communicated to the customer 206 according to his request at least once before the adjusted appointment time. There also could be reminders of the appointment in the days before the day of the appointment.

Where appropriate, advertisers could buy advertising time from the service provider, his company or organization. Such advertising 204 could be made general for all customers or specific for the particular customer and his current situation. This would be more effective for the advertisers who wish to target their adverts more accurately. These details could include gender, age and the length of time spare between the advertisement being sent and the customer's appointment. The advertisement could apply also to the period of time after the appointment but that would be less effective than those periods of “dead” time before the appointment. The advertiser would know the specific business of the service provider and appropriate advertisers would advertise accordingly. For example, the offices of the government issuing passports, may attract advertisers of holidays abroad or a dentist surgery may attract advertisements of toothpaste.

Once the customer has finished his appointment, this would be communicated to the said computer program and that particular customer would be cancelled 208 from the list of customers for that day.

The present invention is not intended to be limited to the embodiments described above, but to encompass any and all embodiments within the scope of the following claims

What is claimed is:

1. A method, system and device for service providers to record appointments and thereafter give prior notice to customers of the approaching appointment time comprising;
a) a software program designed to process various aspects, options and factors including at least one of the following namely, the optional possible dates and times for the appointment offered by the said customer, the optional possible dates and times for the appointment available by the said service provider, the nature of the appointment, the average length of time that service provider or employee of the service provider takes for a similar kind of appointment, in order to establish dates of appointments and enable the calculation of the estimated time for each appointment made and communication to and from the said customer,
b) a means of communication to the said customer, and
c) a means of communication by the said customer to the said service provider
whereby the said service provider can run its business more efficiently and the said customer will better utilize his time, knowing when his appointment is expected to take place.

2. A method, system and device as claimed in claim 1 wherein the said appointment is made at the relevant offices.

3. A method, system and device as claimed in claim 1 wherein the said appointment is made remotely.

4. A method, system and device as claimed in claim 1 wherein the said software includes a computer program is made to accept input information, calculate estimated appointment times and communicate the same to customers with appointments.

5. A method, system and device as claimed in claim 4 wherein the said input information includes relevant detail about the said service provider.

6. A method, system and device as claimed in claim 4 wherein the said input information includes relevant detail about the nature of the appointment.

7. A method, system and device as claimed in claim 4 wherein the said input information includes relevant detail of the average times for appointments with the said service provider and similar type of appointments.

8. A method, system and device as claimed in claim 4 wherein the said input information includes relevant detail concerning fixed predictable breaks during the course of the workday.

9. A method, system and device as claimed in claim 4 wherein the said input information includes relevant detail concerning irregular breaks on that particular day.

10. A method, system and device as claimed in claim 1 wherein advertisers are able to communicate to the said customers the subject matter of the said advertising being based on the nature of appointment.

11. A method, system and device as claimed in claim 10 wherein the said advertising is chosen and adjusted to take into account the personal details of the customer and the time available before the appointment.

12. A method, system and device as claimed in claim 1 wherein the customer could communicate with the said computer program to establish the updated estimate time of the said appointment.

13. A method, system and device as claimed in claim 1 wherein the said communication is vocally to a telephone.

14. A method, system and device as claimed in claim 1 wherein the said communication is in digital writing, like for example, SMS.

15. A method, system and device as claimed in claim 1 wherein the said customer chooses the times prior to the appointment that he wishes to receive a reminder.

16. A method, system and device as claimed in claim 1 wherein there is at least one default time prior to the said appointment that the said customer is sent the said reminder, failing the said choice by the said customer.

17. A method, system and device as claimed in claim 1 wherein the said computer program is programmed to remove from its list of customers for appointments that day, those said customers who commenced the interview with the said service provider.

18. A method, system and device as claimed in claim 1 wherein the said computer program is programmed to communicate with customers who fail to arrive for the said appointment, for the purpose of establishing another appointment.
